(19) United States
(12) Patent Application Publication
(10) Pub. No.: US 2018/0361806 A1
(43) Pub. Date: Dec. 20, 2018

(54) Adjustable Control Valve Stem

(71) Applicant: Benjamin J. KREMPEL, Saint Charles, IL (US)

(72) Inventors: Benjamin J. KREMPEL, Saint Charles, IL (US); Derek MORAN, Goleta, CA (US); Cyrus KLIEWER, Morgan Hill, CA (US)

(21) Appl. No.: 16/060,492

(22) PCT Filed: Dec. 8, 2016
(86) PCT No.: PCT/US2016/065646

§ 371 Date: Jun. 8, 2018

Related U.S. Application Data
(60) Provisional application No. 62/264,952, filed on Dec. 9, 2015.

(51) Int. Cl. B60C 23/12; B60C 29/00; B60C 29/06

(52) U.S. Cl. CPC B60C 23/12; B60C 29/005; B60C 29/02; B60C 2200/12; B60C 29/066

(57) ABSTRACT

A pneumatic control device is provided designed to work with self-inflating inner tubes and tires, specifically for bicycles or wheelchairs. The device distinguishes a stem assembly and an air control assembly. The device allows users to set a desired pressure and maintains that constant pressure over time, thereby eliminating the need to manually re-fill the tires. The device is compatible with current rims and tires and requires no modification to be installed to existing rims. The device works by regulating the intake of air from the atmosphere into the self-inflating pumping mechanism. Once the desired pressure is reached, the system stops new air from entering the self-inflating mechanism.

### FIELD OF THE INVENTION

The invention relates to pneumatic control devices for pneumatic tires.

### BACKGROUND OF THE INVENTION

Self-inflating inner tubes and tires are solutions to air loss in pneumatic tires, which lose air through diffusion. Bicycle wheels typically have a rim and a tire, and may or may not include an inner tube. Whether the wheel uses an inner tube or not, air inflates the tire usually through a valve stem, which passes through a hole in the rim. Although there are many different valve stem designs the great majority of bicycle wheels use either Presta or Schrader valves. Presta valve stems have the advantage of having a smaller stem diameter than Schrader valves. The Presta stem is approximately 6 mm in diameter.

Current Presta valve designs have been refined over many years. These designs distinguish a stem and a check valve attached to the inner tube with a rubber foot. In some cases the check valve is designed with a removable core, which allows the core to be replaced if desired. A compressed air source can be screwed to the threads of the Presta valve stem to inflate the tire. Pushing down on the top of the check valve allows the air to escape and deflate the tire.

The present invention advances the art by providing a pneumatic control device for limiting or controlling the pressure within the pneumatic chamber of a tire.

### SUMMARY OF THE INVENTION

A pneumatic control device is provided designed to work with self-inflating inner tubes and tires, especially for bicycles or wheelchairs. The device distinguishes a stem assembly and an air control assembly. The stem assembly is adapted to be mounted through a rim of a wheel. Specifically, the stem assembly has a stem and a tubing assembly. The stem has a hollow passageway through the stem from the top end to the bottom end of the stem. The tubing assembly is adapted to fit within the hollow passageway of the stem, and distinguishes a first tubing and a second tubing both adapted to fit within an inner tube or tire near the bottom end of the stem. The first tubing connects pneumatically to the chamber of the tire or inner tube. The second tubing connects pneumatically to the pumping mechanism.

The air control assembly is adapted to be pneumatically mounted to the top of the stem assembly, and include the following components: a ball seat, a housing, a housing seal, an air pressure adjuster, a spring guide, an air pressure selector spring, a check ball, a valve core, a valve core spring and a cap.

The housing has an air passage through the housing from the top end to the bottom end of the housing. The bottom end of the housing is adapted to be screwed onto the top end of the stem assembly pneumatically sealing both pieces together.

The air pressure adjuster has an air passage through the air pressure adjuster from the top end to the bottom end of the pressure adjuster. The air pressure adjuster is adapted to be pneumatically affixed to the top end of the housing.

A spring guide aligns the air pressure selector spring within the housing.

A check ball is positioned in between a ball seat and the air pressure selector spring. The diameter of the check ball is at least larger than the inner diameter of the air pressure selector spring. Further the diameter of the check ball together with the ball seat are adapted to pneumatically seal the chamber of the tire from the air control assembly. Air pressure from the chamber of the tire passes through the first tubing and pushes against the check ball opposite the air pressure selector spring thereby regulating the pressure in the tire.

The valve core is adapted to be screwed on the top end of the air pressure adjuster and is further adapted to fit to an air source. For example, valve core V002 from the Luhai Holding Corp located in Tien-chung, Chang-hua Taiwan, could be used for this application.

The valve core spring is arranged in between the valve core and the top end of the air pressure adjuster. The valve core spring is designed to maintain the valve core in a closed position. The air pressure selector spring can be compressed or decompressed by respectively screwing the air pressure adjuster towards or screwing the air pressure adjuster away from and relative to the top end of the housing, therewith through the amount of force applied by the air pressure selector spring onto the check ball.

In some specific embodiments, the pneumatic control device has some variations such as that it is compatible with a rim for a Presta fitting or a Schrader fitting, the housing has markings (visible indicators, gradient lines, color coded indicators, or pictures) for indicating air pressure, the cap could be a removable cap with an air filter adapted to be affixed to the valve core, the valve core could be a removable valve core, and/or the check ball has a diameter of about 2-5 mm. Check balls are commonly available in industry and the nitrile rubber, 4 mm diameter check ball with product number 1400.156-70 from Precision Plastic Ball located in Franklin Park, Ill., U.S. could be used for this application.

Some advantages of the device are:
the air control assembly can be removed from the stem and serviced while the tire is still mounted on the rim.
The precision and regulation of the tire pressure can be adjusted by replacement of the air pressure selector spring while the valve stem is still mounted on the rim, and the pressure is user-adjustable while mounted to the tire.
A novice cyclist can use the system without training.
The design allows the tire to be inflated using a compressed air source such as a floor pump and the self-inflating mechanism without any adjustments by the user. For example, the first time a new inner tube or tire is mounted to the rim, the wheel must be inflated with a compressed air source. Afterwards, tire pressure can be maintained by the self-inflating mechanism. The user is not required to switch between these two modes.
The design allows the user to deflate the tire by unscrewing the air pressure adjuster or removing it completely. This is important for reducing tire pressure or for completely deflating the tire to remove it from the rim.
The user can easily set the desired pressure. This allows users to adjust tire pressure to optimize ride quality, handling, tire efficiency for rider weight, environmental conditions and usage.
The device is compatible with current rims without modification, making it easy and inexpensive to install on existing bicycles and wheel chairs.
The device stops the self-inflating mechanism from over-inflating the tire.

### BRIEF DESCRIPTION OF THE DRAWINGS

FIG. 1 shows a pneumatic control device according to an exemplary embodiment of the invention/

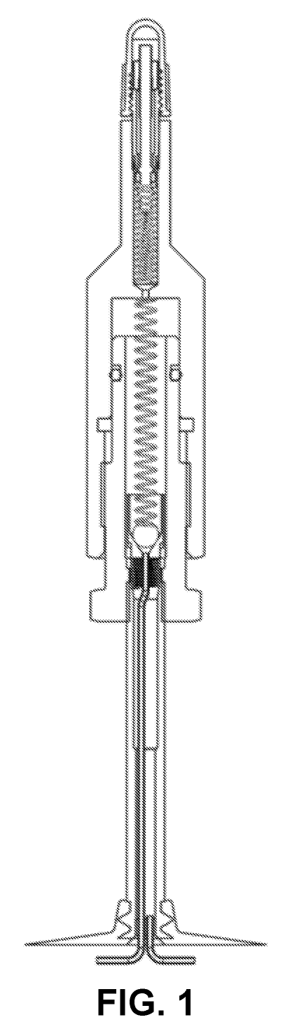

FIG. 2 shows according to an exemplary embodiment of the invention an exploded view of the pneumatic control device shown in FIG. 1. In FIG. 2, the following elements are shown: 1. a cap, 2. a valve core, 3. a valve core spring, 4. an air pressure adjuster, 5.

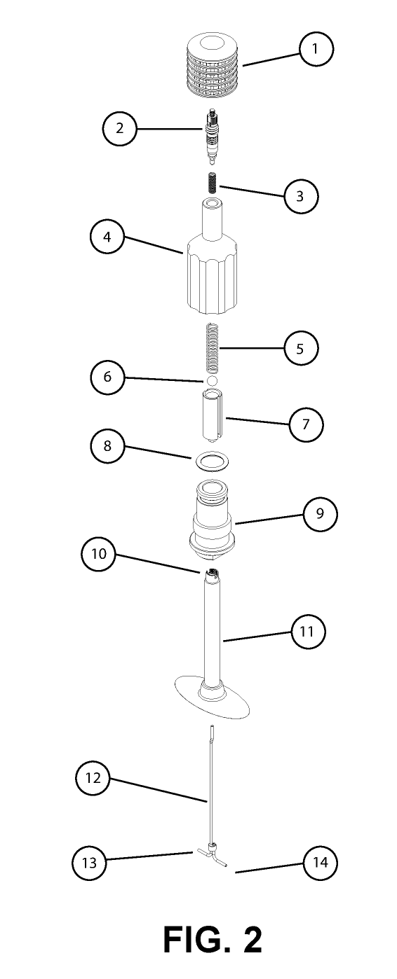

an air pressure selector spring, 6. a check ball, 7. a spring guide, 8. a housing seal 9. a housing, 10. a ball seat, 11. a stem, 12. a tubing assembly, 13. a first tubing, 14. a second tubing

FIG. 3 shows according to an exemplary embodiment of the invention the pneumatic control device similar as shown in FIG. 1 indicating a first air passage way tubing 13 where air from the inner tube or tire can be passed and pneumatically act onto check ball 6, and a second air passage way tubing 14 where air from the atmosphere can be drawn into the inner tube or tire via part of the spring guide 7 and through the air passage way of stem 11.

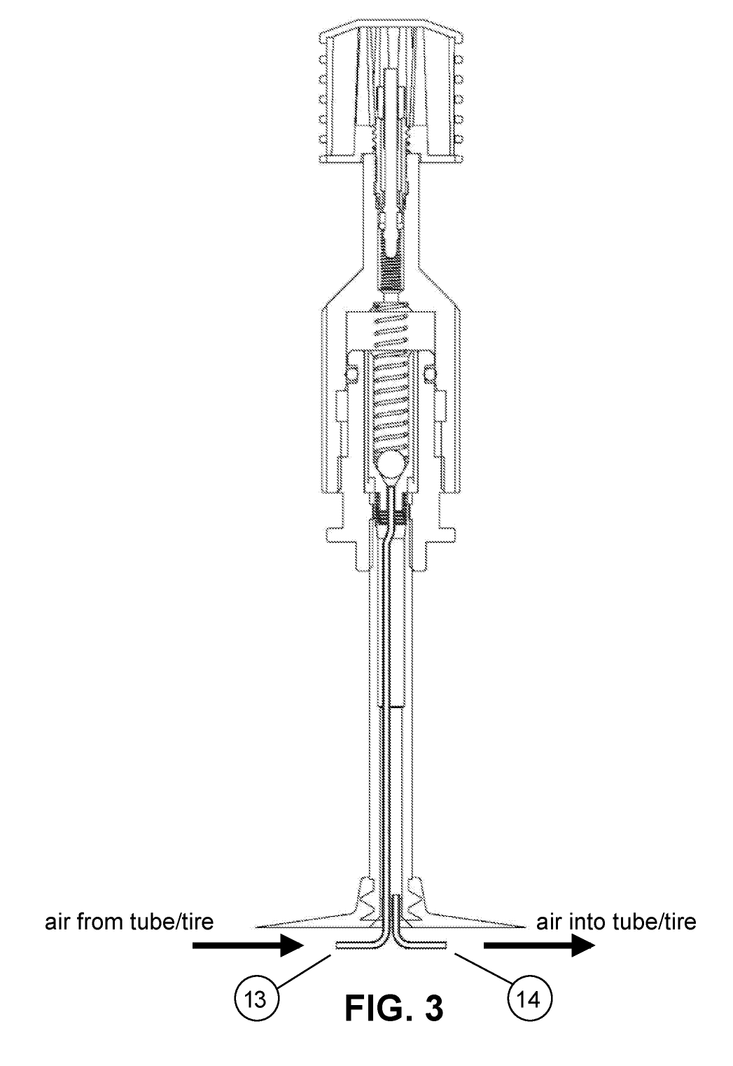

FIG. 4 shows according to an exemplary embodiment of the invention a modified cap 1′ compared to the cap shown in FIG. 1. Cap 1 has a support base 15 for the cap and a filter 16 within support base 15.

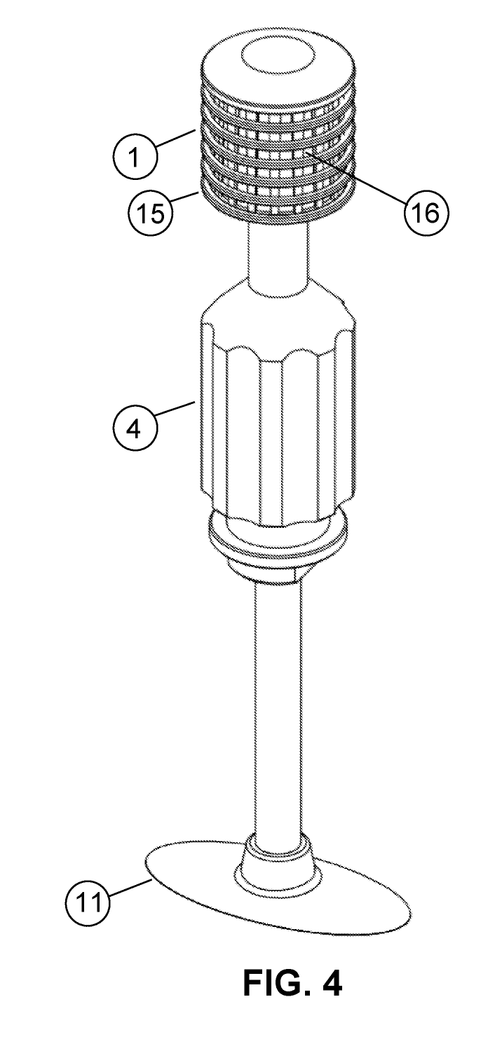

### DETAILED DESCRIPTION

An embodiment of the invention is a pneumatic control device designed to work with self-inflating inner tubes and tires. In its most basic form the device is able to fulfill the following functions:
1) Allows the tire to be inflated with a compressed air source attached to the valve stem.
2) Regulates the pressure in the tire by stopping air from the atmosphere from entering the tire.
3) Allows the air to be discharged from the tire from the valve stem.

Each of these three functions is important. The tire must be able to be inflated when initially mounted to the rim and the tire must be able to be deflated to dismount the tire from the rim.

In addition to the basic form, the device may perform some or all of the following functions:
1) Filter the air before it enters the tire.
2) Offer the user the ability to set the desired pressure within a range.
3) Be serviceable by the user.
4) May be mounted on Schrader and Presta compatible rims without modification.
5) May exhaust compressed air from the tire to regulate pressure, although this is not the preferred regulation method.
6) May use a check valve core assembly found in industry to reduce manufacturing cost, engineering time and increase reliability and serviceability.

The device differs from a typical valve stem in that the device has two air passageways through the valve stem. One passage way is for air to enter and exit the tire. The other passage way is to activate a control valve. In the current embodiment of the invention, air pressure from the main chamber of the tire pushes up on the check ball stopping new air from the atmosphere from entering the valve stem.

In this disclosure, we speak of tire pressure for the sake of simplicity and we do not differentiate between air entering the inner tube or air entering the tire. We do not differentiate between inner tube pressure and tire pressure knowing that the device may be applied equally to pneumatic tires that use inner tubes and pneumatic tires that do not use inner tubes.

### How the Device is Attached to a Wheel

The device is easily mounted to the rim by pushing the stem assembly through the rim and then screwing on the air control assembly to the stem The stem assembly distinguishes elements 11-14. The control assembly distinguishes elements 1-10.

In one embodiment, the stem assembly passes through the hole in the rim placed there for a typical valve stem. The air control assembly is then screwed down on to the stem assembly. The stem assembly is held fixed to the rim either by the air control assembly pushing against the rim or an optional nut, which would fix the stem assembly to the rim. At this point the tire can be inflated with a compressed air source. Approximately 1 bar minimum pressure is needed to stabile the tire on the rim and enable the bicycle to be ridden. The tire could also be inflated to the desired pressure at this point. The last step is to adjust the air control assembly to the desired pressure.

### Setting the Tire Pressure

Turning the air pressure adjuster 4 sets the tire pressure. The maximum set pressure is achieved when the pressure adjustor is screwed down to its lowest point. The minimum set pressure is achieved by unscrewing the pressure adjuster to its highest point. Markings may be included on housing 9 to indicate the pressure settings. Markings may be indicators such as lines, geometric shapes, dots, arrows or other figures. Units may include general indicators such as higher or lower or may be in pounds per square inch (psi), bar or other recognized units. Markings may be monochrome or color-coded.

### Pressure Range and Precision

An advantage of the device it that different springs can be used to optimize the adjustment range and precision for different riders and applications. For example an urban commuter bike could be optimized for both heavy and light loads by incorporating a wide range of pressures. With a heavy load or heavy rider, the tires might perform best at 4 bar pressure. With a light load or light rider, the tires might perform best at 3 bar pressure. For this application, a spring could be chosen that regulates the pressure from 2.5-4-5 bar with an error range of +/−0.25 bar. In another application the spring could be exchanged with another to regulate within a smaller range, but with much greater precision. For example the range of pressure regulation could be reduced to 4.0-4.5 bar with an error range of +/−0.10 bar. For certain applications precision will take precedence over range and vice versa. The current embodiment is designed for the urban commuter and has an adjustable pressure range of 2.5-4.5 bar.

### Digital Pressure Monitoring

The device may have an electronic pressure monitoring means. For example a battery powered pressure monitor may be included in the system and may transmit the data via Bluetooth or other electrical means to a receiver on the bicycle. This would create a means for users to be able to easily verify the pressure in their tires and be informed if the tire pressure moves outside of a desired range. Such stand-alone monitoring systems are already available for bicycles, motorcycles and automotive use. The electric pressure monitoring means may be located within the tire or may be located outside the tire on the valve stem.

### Materials

Pneumatic valves have been refined over many years and are currently made of a variety of materials to optimize for specific applications. The bicycle industry is very weight sensitive and lightweight plastics, rubbers, metals, resins and composites could be used. For example valve stems are typically made out of steel, brass and other metals due to the range of stresses and impacts they must withstand. In the current design, there is great flexibility in the material choice for the housing, air spring guide and other components. The elements of the device could be made from metal, plastic, rubber, resins, composites, alloys, carbon fiber or any other material available.

### Check Ball Design

One of the aspects of the design that enhances performance and precision is the large size of the check ball. Generally speaking, a larger check ball enhances the operation of the valve as it permits more airflow through the valve improving valve performance. A larger check ball allows for spring design with lower stress and a more advantageous spring index. A larger check ball minimizes the effects of manufacturing tolerances resulting in more predictable performance and therefore lower hysteresis between the open and closed positions.

### Mode of Operation

The adjustable control valve has two modes of operation. In the first mode, the adjustable control valve allows air from the atmosphere to enter through the valve stem and into the main chamber of a bicycle tire. In the second mode, the adjustable control valve limits at least partially the flow of air from the atmosphere into the main chamber of the bicycle tire.

In the first mode, when the wheel is at rest the pressure from the main chamber of the tire pushes against the first check valve. The first check valve is located in the valve core. The first check valve stops the pressurized air from escaping out of the tire. When the self-inflating means is activated, usually by riding the bike and putting a load on the tire, the self-inflating means draws a vacuum, which reduces the air pressure in the valve stem to below atmospheric pressure and opens the first check valve. The first check valve may employ a spring to positively keep the first check valve in the closed position. Air from the atmosphere is pulled through the first check valve all the way through the base and into the pumping mechanism where it is forced into the main chamber of the tire.

In the second mode, the pressure in the main chamber of the tire exceeds the set pressure of the adjustable control valve stem. This usually occurs when the self-inflating means is activated. The pressure from the main chamber of the tire exceeds the spring force of the pressure selector spring and releases air into the stem assembly. This pressurized air immediately pushes against the first check valve thereby closing it and stopping new air from the atmosphere from entering the stem assembly. The released, pressurized air flows back into the pumping mechanism. If the self-inflating mechanism is active, i.e., pumping, it will recirculate air from the main chamber into the pumping mechanism and not draw new air in from the atmosphere. In this scenario, the pumping mechanism will do no work and no pressurized air is lost to the atmosphere.

What is claimed is:

1. A pneumatic control device to control pressure designed to work with self-inflating inner tubes and tires, comprising:
(a) a stem assembly adapted to be mounted through a rim of a wheel, wherein the stem assembly comprises a stem with an air passage through the stem from the top end to the bottom end of the stem, and a tubing assembly adapted to fit within the air passage of the stem; and
(b) an air control assembly adapted to be pneumatically mounted to the top of the stem assembly,
wherein the tubing assembly has a first passage for air to enter and exit the inner tube or tire, and a second passage to activate the air control assembly, and wherein the air control assembly comprises a user-adjustable air pressure adjuster.

2. The pneumatic control device as set forth in claim 1, wherein the pneumatic control device is compatible with a rim for a Presta fitting or a Schrader fitting.

3. The pneumatic control device as set forth in claim 1, wherein the pneumatic control device is for a bicycle tire or inner tube.

4. The pneumatic control device as set forth in claim 1, wherein the pneumatic control device is for a wheelchair tire or inner tube.

5. The pneumatic control device as set forth in claim 1, wherein the pneumatic control has markings or indicators for indicating air pressure.

6. The pneumatic control device as set forth in claim 1, further comprising a removable cap with an air filter adapted to be affixed to the valve core.

7. The pneumatic control device as set forth in claim 1, wherein the air control assembly comprises a check ball has a diameter of about 2-5 mm.
